(19) United States
(12) Patent Application Publication
(10) Pub. No.: US 2015/0221932 A1
(43) Pub. Date: Aug. 6, 2015

(54) POSITIVE-ELECTRODE ACTIVE MATERIAL FOR LITHIUM SECONDARY BATTERY, MANUFACTURING METHOD THEREFOR, POSITIVE ELECTRODE FOR LITHIUM SECONDARY BATTERY, AND LITHIUM SECONDARY BATTERY PROVIDED WITH SAID POSITIVE ELECTRODE

(71) Applicant: TAYCA CORPORATION, Osaka-shi, Osaka (JP)

(72) Inventors: Katsuya Sawada, Osaka-shi (JP); Keiichi Watanabe, Osaka-shi (JP); Shuji Nishida, Osaka-shi (JP)

(73) Assignee: TAYCA CORPORATION, Osaka-shi, Osaka (JP)

(21) Appl. No.: 14/419,593

(22) PCT Filed: Aug. 7, 2013
(86) PCT No.: PCT/JP2013/071375

§ 371 Date: Feb. 4, 2015

(30) Foreign Application Priority Data
Aug. 10, 2012 (JP) 2012-179088

(51) Int. Cl. H01M 4/36; H01M 4/587; H01M 10/0525; H01M 4/525

(52) U.S. Cl. CPC H01M 4/364; H01M 4/525; H01M 4/587; H01M 10/0525; H01M 2004/028

(57) ABSTRACT

To provide the following: a positive-electrode active material for a lithium secondary battery, said material being inexpensive to synthesize and having good storage characteristics after battery manufacture; a manufacturing method therefor; a positive electrode provided with said positive-electrode active material; and a lithium secondary battery provided therewith. [Solution] This positive-electrode active material for a lithium secondary battery contains a carbonaceous material and iron-containing lithium titanate that has a cubic rock-salt structure and can be represented by the composition formula Li₁₊ₓ(Ti_{1-y}Fe_{y})₁₋ₓO₂ (with 0<x≦0.3 and 0<y≦0.8). Said carbonaceous material and iron-containing lithium titanate are complexed together via a mechanochemical treatment. A method for manufacturing this positive-electrode active material for a lithium secondary battery includes the following steps: a coprecipitation step in which a solution containing an iron source and a titanium source is neutralized by an alkaline solution, washed with water, and dried to produce a Fe—Ti coprecipitate; a mixing step in which said coprecipitate is mixed with a lithium source to produce a mixture; a calcination step in which said mixture is calcined to produce a calcination product; and a complexing step in which said calcination product is complexed with a carbonaceous material via a mechanochemical treatment.

### TECHNICAL FIELD

The present invention relates to a positive-electrode active material for a lithium secondary battery, a manufacturing method therefor, a positive electrode for a lithium secondary battery, and a lithium secondary battery.

### BACKGROUND ART

Hitherto, iron-containing lithium titanate has been used as one of positive-electrode materials for lithium secondary batteries. As a method for producing iron-containing lithium titanate, the following method has been proposed: for example, a method in which after a coprecipitate mixture obtained by coprecipitating and ageing a titanium source and iron source which are starting materials is mixed in a strong alkali containing a lithium source, a target product is synthesized through steps such as hydrothermal treating, water washing, and drying.

The following oxide is described in, for example, Japanese Patent No. 3914981 (Patent Literature 1): a lithium ferrite-based oxide which is used as a positive-electrode material for lithium secondary batteries, which is represented by the composition formula Li₂₋ₓTi_{1-z}Fe_{z}O_{3-y} (0≦x<2, 0≦y≦1, 0.05≦z≦0.95), and which has a cubic rock-salt structure. Furthermore, a method for producing the lithium ferrite-based oxide is described therein, the method being characterized in that a mixed solution containing a water-soluble titanium salt and a water-soluble iron salt is coprecipitated with alkali, an obtained precipitate is hydrothermally treated within the temperature range of 101° C. to 400° C. together with an oxidizing agent and a water-soluble lithium compound, and impurities such as a surplus of a lithium compound are then removed from a hydrothermal treatment reaction product. Furthermore, a positive-electrode material, containing the lithium ferrite-based oxide, for lithium ion secondary batteries and a lithium ion secondary battery are described therein.

Furthermore, the following method is described in Japanese Unexamined Patent Application Publication No. 8-295518 (Patent Literature 2): a method for synthesizing lithium iron oxide, the method including a step of heating a starting material containing at least iron oxyhydroxide and a lithium compound in an atmosphere containing steam. Furthermore, the following battery is described therein: a lithium battery including an electrode that includes lithium iron oxide which is obtained by the above synthesizing method, which has a zigzag layered structure, and which is represented by LiₓFeO₂ (0<x≦2) and also includes an electrolyte layer having at least lithium ion conductivity.

The following oxide is described in Japanese Unexamined Patent Application Publication No. 10-120421 (Patent Literature 3): lithium iron oxide which has a tunnel structure that is of the same type as akaganeite β-FeO(OH) and which is represented by LiₓFeO₂ (where, 0<x<2). Furthermore, the following method is described therein: a method for producing the above lithium iron oxide, the method being characterized in that an alcohol suspension containing akaganeite β-FeO(OH) and a lithium compound is heated to a temperature of 50° C. or higher. Furthermore, the following battery is described therein: a lithium battery which includes a lithium-ion conductive electrolyte and a pair of electrodes and in which at least one of the electrodes contains the above lithium iron oxide.

### CITATION LIST

### Patent Literatures

PTL 1: Japanese Patent No. 3914981

PTL 2: Japanese Unexamined Patent Application Publication No. 8-295518

PTL 3: Japanese Unexamined Patent Application Publication No. 10-120421

### SUMMARY OF INVENTION

### Technical Problem

However, such conventional iron-containing lithium titanate as disclosed in Patent Literatures 1 to 3 has insufficient storage characteristics (characteristics of suppressing the voltage drop during storage) when being used as a positive-electrode active material for lithium secondary batteries.

In particular, in the case of using a hydrothermal reaction method which is a common method for synthesizing such a composite oxide as disclosed in Patent Literature 1, a large amount of moisture adheres to the surface of obtained iron-containing lithium titanate. As a result, there is a problem in that a lithium secondary battery using such iron-containing lithium titanate has reduced storage characteristics.

In particular, in the hydrothermal reaction method, a large amount of a lithium source needs to be used in a hydrothermal treatment step and therefore the unreacted lithium source remains on the surface of iron-containing lithium titanate even though a subsequent water-washing step is performed. As a result, the unreacted lithium source remains on the surface of iron-containing lithium titanate even though a subsequent drying step is performed, so that the unreacted lithium source is likely to react with moisture in air. Thus, in the case of using such iron-containing lithium titanate as a positive-electrode material for lithium secondary batteries, the reduction of storage characteristics (the voltage drop due to the dissolution of an element such as Fe during high-temperature storage and the generation of gas during charge or discharge) is caused by the influence of attached moisture.

Furthermore, since iron-containing lithium titanate obtained by a hydrothermal reaction method described in Patent Literature 1 contains a remaining alkali component such as a lithium source, the pH of an active material is high. Therefore, there is a problem in that the deterioration of a binder used for a lithium secondary battery arises to cause gelation, which has an adverse influence on coating.

Furthermore, since such conventional producing methods as disclosed in Patent Literatures 1 to 3 take a very long time for synthesis (refer to paragraphs [0028] and [0029] of Patent Literature 1, paragraph [0014] of Patent Literature 2, and paragraph [0018] of Patent Literature 3), there is a problem in that a heating facility is large. There is also a problem in that costs are high.

This time, the inventors have performed intensive investigations and, as a result, have obtained a finding that a positive-electrode active material for a lithium secondary battery can be obtained by mechanochemically treating iron-containing lithium titanate with a carbonaceous material, the positive-electrode active material being capable of enhancing storage characteristics and initial battery characteristics of a lithium secondary battery in the case of use as a positive-electrode active material of a lithium secondary battery. Furthermore, the following finding has been obtained: a finding that a lithium secondary battery having more excellent storage characteristics and initial battery characteristics can be obtained by adjusting the crystallite diameter, the moisture content, the specific surface area, and the like within a specific range.

Furthermore, the following finding has been obtained: a finding that the amount of a lithium source used can be reduced and iron-containing lithium titanate can be prepared in a short time by the use of a microwave for a heating means during the synthesis of iron-containing lithium titanate.

As a result, the unreacted lithium source remaining on the surface of iron-containing lithium titanate can be reduced. In the case of using such iron-containing lithium titanate for a positive-electrode active material of a lithium secondary battery, the dissolution of an element such as Fe due to the adsorption of moisture during high-temperature storage and the generation of gas during charge or discharge can be suppressed. From this point, the following finding has been obtained: a finding that a lithium secondary battery with excellent storage characteristics can be obtained.

That is, the present invention has been made in view of the above circumstances. It is an object of the present invention to provide a positive-electrode active material for a lithium secondary battery, the positive-electrode active material being capable of obtaining a lithium secondary battery with more excellent storage characteristics (characteristics of suppressing the voltage drop during storage) than ever. Furthermore, it is an object of the present invention to provide a manufacturing method capable of obtaining the positive-electrode active material in an extremely short time and at low cost.

### Solution to Problem

A positive-electrode active material for a lithium secondary battery according to the present invention contains a carbonaceous material and iron-containing lithium titanate that has a cubic rock-salt structure and can be represented by the composition formula Li₁₊ₓ(Ti_{1-y}Fe_{y})₁₋ₓO₂ (with 0<x≦0.3 and 0<y≦0.8). Said carbonaceous material and iron-containing lithium titanate are complexed together via a mechanochemical treatment.

This positive-electrode active material for a lithium secondary battery according to the present invention preferably contains 0.5% to 10% by weight of said carbonaceous material.

In this positive-electrode active material for a lithium secondary battery according to the present invention, the crystallite diameter of iron-containing lithium titanate is preferably 5 nm to 100 nm.

This positive-electrode active material for a lithium secondary battery according to the present invention preferably has a moisture content of 2,000 ppm or less.

This positive-electrode active material for a lithium secondary battery according to the present invention preferably has a specific surface area of 20 m²/g to 150 m²/g as determined by the BET method.

This positive-electrode active material for a lithium secondary battery according to the present invention preferably has a voltage drop rate of 5% or less as calculated from the following equation:

(voltage drop rate)=((voltage just after charge−voltage measured after storage for 30 days)/(voltage just after charge))×100(%).

A method for manufacturing this positive-electrode active material for a lithium secondary battery according to the present invention includes the following steps: a coprecipitation step in which a solution containing an iron source and a titanium source is neutralized by an alkaline solution, washed with water, and dried to produce a Fe—Ti coprecipitate; a mixing step in which said coprecipitate is mixed with a lithium source to produce a mixture; a calcination step in which said mixture is calcined to produce a calcination product; and a complexing step in which said calcination product is complexed with a carbonaceous material via a mechanochemical treatment.

In the method for manufacturing this positive-electrode active material for a lithium secondary battery according to the present invention, said calcination step is preferably performed in an inert gas atmosphere.

In the method for manufacturing this positive-electrode active material for a lithium secondary battery according to the present invention, said calcination step is preferably performed at a temperature of 400° C. to 700° C.

A method for manufacturing this positive-electrode active material for a lithium secondary battery according to the present invention includes the following steps: a coprecipitation step in which a solution containing an iron source and a titanium source is neutralized by an alkaline solution, washed with water, and dried to produce a Fe—Ti coprecipitate; a mixing step in which said coprecipitate is mixed with a lithium source to produce a mixture; a synthesis step in which said mixture is irradiated with a microwave to produce iron-containing lithium titanate; and a complexing step in which iron-containing lithium titanate is complexed with a carbonaceous material via a mechanochemical treatment.

In the method for manufacturing this positive-electrode active material for a lithium secondary battery according to the present invention, said synthesis step is preferably performed at a temperature of 100° C. to 250° C.

In the method for manufacturing this positive-electrode active material for a lithium secondary battery according to the present invention, said iron source is preferably one or more of Fe₂(SO₄)₃, FeSO₄, FeCl₃, and Fe(NO₃)₃.

In the method for manufacturing this positive-electrode active material for a lithium secondary battery according to the present invention, said titanium source is preferably one or more of Ti(SO₄)₂, TiOSO₄, and TiCl₄.

A positive electrode for a lithium secondary battery according to the present invention includes a layer which is placed on a surface of a current collector and which is made of this positive-electrode active material for a lithium secondary battery.

A lithium secondary battery according to the present invention is provided with said positive electrode for a lithium secondary battery.

### Advantageous Effects of Invention

As described above, according to the present invention, the following can be provided: a positive-electrode active material for a lithium secondary battery, said material being inexpensive to synthesize and having good storage characteristics after battery manufacture; a manufacturing method therefor; a positive electrode provided with said positive-electrode active material; and a lithium secondary battery provided therewith.

Furthermore, in accordance with this positive-electrode active material for a lithium secondary battery according to the present invention, a lithium secondary battery having more excellent storage characteristics and initial battery characteristics can be obtained by adjusting the crystallite diameter, the moisture content, the specific surface area, and the like within a specific range.

Furthermore, in accordance with the method for manufacturing this positive-electrode active material for a lithium secondary battery according to the present invention, nuclei can be produced without causing any unnecessary side reaction because iron-containing lithium titanate is synthesized by applying a microwave.

Furthermore, a uniform crystal can be obtained in a short synthesis time, the consumption of a lithium source by oxidation can be suppressed, and the amount of the mixed lithium source can be reduced. As a result, the lithium source remaining on the surface of iron-containing lithium titanate after synthesis can be reduced.

In the case where such iron-containing lithium titanate is mechanochemically treated with a carbonaceous material and is used for a positive-electrode active material of a lithium secondary battery, a lithium secondary battery having excellent storage characteristics and initial battery characteristics can be obtained.

### Description of Embodiments

Embodiments of the present invention are described below. Incidentally, the embodiments described below are merely examples obtained by embodying the present invention and do not limit the technical scope of the present invention.

(Basic Structure)

A positive-electrode active material for a lithium secondary battery according to the present invention contains a carbonaceous material and iron-containing lithium titanate which has a cubic rock-salt structure and which is represented by the composition formula Li₁₊ₓ(Ti_{1-y}Fe_{y})₁₋ₓO₂ (with 0<x≦0.3 and 0<y≦0.8). The carbonaceous material and iron-containing lithium titanate are complexed together via a mechanochemical treatment.

Raw materials (an iron source, a titanium source, a lithium source, an alkaline solution, and the carbonaceous material) of the positive-electrode active material for a lithium secondary battery according to the present invention are those cited below.

(Iron Source)

The iron source is preferably one or more of Fe₂(SO₄)₃, FeSO₄, FeCl₃, and Fe(NO₃)₃. Incidentally, the iron source may be used alone or in combination. Among these, Fe₂(SO₄)₃ is more preferably used as the iron source in consideration of cost and handleability during crystallization.

(Titanium Source)

The titanium source is preferably one or more of Ti(SO₄)₂, TiOSO₄, and TiCl₄. Incidentally, the titanium source may be used alone or in combination. Among these, TiOSO₄ is more preferably used as the titanium source in consideration of solubility in water and the like.

(Lithium Source)

The lithium source is preferably, for example, Li₂CO₃, LiOH.H₂O, or CH₃COOLi. Incidentally, the lithium source may be used alone or in combination. Among these, LiOH.H₂O is preferably used in consideration of cost and reactivity.

(Alkaline Solution)

An aqueous solution of ammonia, sodium hydroxide, potassium hydroxide, sodium carbonate, or the like is cited as the alkaline solution. Among these, the aqueous ammonia solution is preferably used from the viewpoint of suppressing a remaining element such as sodium which is supposed to have an influence on battery performance.

For example, acetylene black, Ketjenblack, carbon black, synthetic graphite, graphite, carbon nanotube, or graphene is used as the carbonaceous material. The carbonaceous material may be used alone or in combination. Among these, Ketjenblack is preferably used from the viewpoint of electrical conductivity, dispersibility, and cost.

The positive-electrode active material for a lithium secondary battery preferably contains 0.5% to 10% and more preferably 0.5% to 5.0% by weight of the carbonaceous material. Adjusting the content of the carbonaceous material to 0.5% by weight or more allows the effect of increasing electronic conductivity to be enhanced. Adjusting the content of the carbonaceous material to 10% by weight or less allows the adsorption of moisture by the carbonaceous material to be suppressed. As a result, storage characteristics can be enhanced. In a positive electrode composed using the positive-electrode active material for a lithium secondary battery as a positive-electrode material, adjusting the content of the carbonaceous material to 10% by weight or less allows the amount of an active material filled in an electrode to be prevented from being reduced.

(Crystallite Diameter)

The positive-electrode active material for a lithium secondary battery according to the present invention preferably uses iron-containing lithium titanate which has a crystallite diameter of 5 nm to 100 nm and which is represented by the composition formula Li₁₊ₓ(Ti_{1-y}Fe_{y})₁₋ₓO₂ (with 0<x≦0.3 and 0<y≦0.8).

The use of iron-containing lithium titanate which contains iron in the above proportion and of which the crystallite diameter is within a specific range allows the positive-electrode active material for a lithium secondary battery to be obtained, the positive-electrode active material being capable of enhancing storage characteristics when being used for a lithium secondary battery. The reason why the crystallite diameter is important in the present invention is that the diffusion length in a crystal affects the size of initial battery capacity when the insertion or deinsertion of Li into or from an iron-containing lithium titanate crystal occurs during charge or discharge.

Incidentally, the crystallite diameter may be within the range of 5 nm to 100 nm, is preferably 10 nm to 80 nm from the viewpoint of initial battery capacity, and is more preferably 10 nm to 40 nm.

(Moisture Content)

The positive-electrode active material for a lithium secondary battery according to the present invention preferably has a moisture content of 2,000 ppm or less and more preferably 1,000 ppm or less.

In particular, in the case of using a microwave for a heating means during the synthesis of iron-containing lithium titanate as described below, the amount of the lithium source used can be reduced. As a result, the unreacted lithium source remaining on the surface of iron-containing lithium titanate can be reduced and therefore the moisture content can be further reduced.

(Specific Surface Area)

Furthermore, the positive-electrode active material for a lithium secondary battery according to the present invention can obtain iron-containing lithium titanate with a small particle size by the use of the microwave. As a result, the positive-electrode active material for a lithium secondary battery has a small particle size after being mechanochemically treated with the carbonaceous material. In particular, the specific surface area is preferably 20 m²/g to 150 m²/g, more preferably 70 m²/g to 120 m²/g, and further more preferably 80 m²/g to 110 m²/g as determined by the BET method.

(Manufacturing Method)

A method for manufacturing the positive-electrode active material for a lithium secondary battery according to the present invention is a method below. That is, the method includes a coprecipitation step in which a solution containing the iron source and the titanium source is neutralized by the alkaline solution, washed with water, and dried to produce a Fe—Ti coprecipitate; a mixing step in which the coprecipitate is mixed with the lithium source to produce a mixture; a calcination step in which said mixture is calcined to produce a calcination product; and a complexing step in which the calcination product is complexed with the carbonaceous material via a mechanochemical treatment.

The calcination step is preferably performed in an inert gas atmosphere. This allows the reaction of the iron source into iron oxide to be suppressed. Gas such as argon, helium, or nitrogen can be used as an inert gas. A nitrogen gas is preferably used as an inert gas in consideration of utility costs for mass production.

In the method for manufacturing the positive-electrode active material for a lithium secondary battery according to the present invention, the calcination step is preferably performed at a temperature of 400° C. to 700° C. Adjusting the calcination temperature to 400° C. or higher allows a synthetic reaction to proceed completely, thereby preventing unreacted substances and intermediate products from remaining. Adjusting the calcination temperature to 700° C. or lower prevents the growth of particles; hence, it can be prevented that relatively large particles affect the diffusion of Li during charge or discharge to reduce battery performance.

Another method for manufacturing the positive-electrode active material for a lithium secondary battery according to the present invention is a method including a coprecipitation step in which a solution containing the iron source and the titanium source is neutralized by the alkaline solution, washed with water, and dried to produce the Fe—Ti coprecipitate; a mixing step in which the coprecipitate is mixed with the lithium source to produce a mixture; a synthesis step in which the mixture is irradiated with the microwave to produce iron-containing lithium titanate; and a complexing step in which iron-containing lithium titanate is complexed with the carbonaceous material via a mechanochemical treatment.

According to this manufacturing method, since synthesis is performed by heating due to applying the microwave, an inner portion of the mixture of the Fe—Ti coprecipitate and the lithium source is irradiated with the microwave and therefore the mixture is uniformly heated at once. Thus, synthesis can be completed in a very short time, about one hour. Furthermore, the consumption of the lithium source by oxidation can be reduced and the amount of the mixed lithium source can be also reduced. As a result, the unreacted lithium source remaining on the surface of iron-containing lithium titanate after synthesis can be reduced and a lithium secondary battery with excellent storage characteristics can be obtained using the positive-electrode active material for a lithium secondary battery.

In the case of a conventional method using a heating means such as an autoclave, heating needs to be performed in an inert gas atmosphere such as nitrogen for the purpose of preventing the iron source from being converted into iron oxide. However, synthesis can be completed in a very short time as described above and therefore synthesis can be carried out without using any inert gas.

Furthermore, heating (calcination) takes only a short time; hence, power-saving in facility can be achieved and manufacturing costs can be reduced.

Incidentally, the temperature and heating time (holding time) during synthesis (the application of the microwave) are not particularly limited and may be appropriately adjusted such that the Fe—Ti coprecipitate reacts adequately with the lithium source. From the viewpoint of allowing the reaction to proceed efficiently, the temperature during synthesis is preferably 100° C. to 250° C. (more preferably 150° C. to 240° C.) and the heating time (holding time) during synthesis is preferably five minutes to 120 minutes (more preferably 30 minutes to 60 minutes).

Furthermore, the power of the microwave is not particularly limited. If the above temperature can be achieved, synthesis can be carried out even with a power of 500 W as used for a common home-use microwave oven.

In the complexing step, complexing is performed via the mechanochemical treatment. The mechanochemical treatment means that properties of a target substance are varied in such a manner that mechanical energy is applied to the target substance by an operation such as shearing, compression, drawing, or friction. In the present invention, the mechanochemical treatment is effective in physically strongly bonding iron-containing lithium titanate and the carbonaceous material together. The mechanochemical treatment can use, for example, a ball mill, such as a planetary ball mill, using a medium; NOBILTA® manufactured by Hosokawa Micron Corporation; Hybridization System® manufactured by Nara Machinery Co., Ltd.; a high-speed mixer manufactured by Earthtechnica Co., Ltd.; or a similar device.

(Positive Electrode for Lithium Secondary Battery)

A positive electrode for a lithium secondary battery can be composed by forming a layer made of the positive-electrode active material for a lithium secondary battery on a surface of a current collector.

(Lithium Secondary Battery)

Furthermore, the positive-electrode active material for a lithium secondary battery according to the present invention has various technical features such as a basic structure, physical properties, and a manufacturing method as described above and therefore the unreacted lithium source remaining on the surface of iron-containing lithium titanate can be reduced. As a result, in the case of using iron-containing lithium titanate for the positive-electrode active material of a lithium secondary battery, a lithium secondary battery with excellent storage characteristics can be obtained.

In particular, the voltage drop rate calculated from the following equation can be adjusted to 5% or less:

(voltage drop rate)=((voltage just after charge−voltage measured after storage for 30 days)/(voltage just after charge))×100(%).

Furthermore, a lithium secondary battery having not only excellent storage characteristics but also excellent initial battery characteristics (large charge capacity, large discharge capacity, and high coulombic efficiency) can be obtained.

Incidentally, a lithium ion secondary battery can be manufactured by a known method using a positive electrode formed from iron-containing lithium titanate according to the present invention, a known negative electrode, and an electrolyte solution. For example, metallic lithium, a carbonaceous material (activated carbon or graphite), or the like can be used as the negative electrode. The following solution can be used as the electrolyte solution: for example, a solution prepared by dissolving a lithium salt such as lithium perchlorate or LiPF₆ in a solvent such as ethylene carbonate or dimethyl carbonate. Furthermore, a lithium secondary battery according to the present invention may include other known elements as battery components.

### EXAMPLES

A positive-electrode active material for a lithium secondary battery according to the present invention and a lithium secondary battery according to the present invention are described below in detail with reference to examples. The present invention is not limited to the examples below. Incidentally, “parts” and “%” are on a weight basis unless otherwise specified.

### Example 1

Titanyl sulfate (TiOSO₄, produced by TAYCA Corporation) and ferric sulfate (Fe₂(SO₄)₃) were weighed such that the Fe/Ti ratio was 1 and were dissolved in 60° C. water, whereby an iron-titanium mixture solution was prepared. Water was poured into another vessel, the iron-titanium mixture and a 28% aqueous solution of ammonia which was a neutralizer were added thereto at once under stirring, and iron and titanium were crystallized with the pH maintained at 8. A crystallized coprecipitate was filtered, was washed with water, was dried, and was crushed, whereby a Fe—Ti coprecipitate was obtained. Lithium hydroxide monohydrate (LiOH.H₂O) was added to the Fe—Ti coprecipitate and was mixed therewith in a planetary ball mill (manufactured by FRITSCH GmbH). The mixture was calcined at 500° C. for five hours in a nitrogen atmosphere, whereby iron-containing lithium titanate was obtained. To the iron-containing lithium titanate, 5% by weight of Ketjenblack (EC600JD, produced by Lion Corporation) serving as a carbonaceous material was added, followed by a mechanochemical treatment using a planetary ball mill under conditions including a rotation speed of 300 rpm and a treatment time of 30 minutes, whereby a positive-electrode active material for a lithium secondary battery of Example 1 was prepared.

### Example 2

A positive-electrode active material for a lithium secondary battery of Example 2 was prepared by performing substantially the same operation as the manufacturing method described in Example 1 except that an iron source was changed to iron (III) chloride (FeCl₃).

### Example 3

A positive-electrode active material for a lithium secondary battery of Example 3 was prepared by performing substantially the same operation as the manufacturing method described in Example 1 except that an iron source was changed to ferrous sulfate (FeSO₄).

### Example 4

A positive-electrode active material for a lithium secondary battery of Example 4 was prepared by performing substantially the same operation as the manufacturing method described in Example 1 except that a titanium source was changed to titanium sulfate (Ti(SO₄)₂).

### Example 5

A positive-electrode active material for a lithium secondary battery of Example 5 was prepared by performing substantially the same operation as the manufacturing method described in Example 1 except that a titanium source was changed to titanium tetrachloride (TiCl₄).

### Example 6

A positive-electrode active material for a lithium secondary battery of Example 6 was prepared by performing substantially the same operation as the manufacturing method described in Example 1 except that the amount of added Ketjenblack was changed to 2.5% by weight in a complexing step.

### Example 7

A positive-electrode active material for a lithium secondary battery of Example 7 was prepared by performing substantially the same operation as the manufacturing method described in Example 1 except that the amount of added Ketjenblack was changed to 10% by weight in a complexing step.

### Example 8

A positive-electrode active material for a lithium secondary battery of Example 8 was prepared by performing substantially the same operation as the manufacturing method described in Example 1 except that the amount of added Ketjenblack was changed to 0.5% by weight in a complexing step.

### Example 9

A positive-electrode active material for a lithium secondary battery of Example 9 was prepared by performing substantially the same operation as the manufacturing method described in Example 1 except that the molar ratio (Fe/Ti ratio) of iron to titanium was changed to 2.3 in a coprecipitation step.

### Example 10

A positive-electrode active material for a lithium secondary battery of Example 10 was prepared by performing substantially the same operation as the manufacturing method described in Example 1 except that the molar ratio (Fe/Ti ratio) of iron to titanium was changed to 0.4 in a coprecipitation step.

### Example 11

A positive-electrode active material for a lithium secondary battery of Example 11 was prepared by performing substantially the same operation as the manufacturing method described in Example 1 except that the calcination temperature was changed to 450° C.

### Example 12

A positive-electrode active material for a lithium secondary battery of Example 12 was prepared by performing substantially the same operation as the manufacturing method described in Example 1 except that the calcination temperature was changed to 650° C.

### Comparative Example 1

In Comparative Example 1, iron-containing lithium titanate was prepared by performing synthesis using a hydrothermal reaction method (autoclave) which was a conventional method during the synthesis of the iron-containing lithium titanate. In particular, the iron-containing lithium titanate was prepared in accordance with Example 1 described in Japanese Patent No. 3914981. The iron-containing lithium titanate was used as a positive-electrode active material for a lithium secondary battery of Comparative Example 1 without performing any mechanochemical treatment with a carbonaceous material.

### Comparative Example 2

Iron (III) oxide (Fe₂O₃, produced by Kojundo Chemical Lab. Co., Ltd.), titanium oxide (TiO₂, produced by TAYCA Corporation), and lithium hydroxide monohydrate (LiOH.H₂O, produced by FMC Corporation) were used as an iron source, a titanium source, and a lithium source, respectively; were weighed such that the molar ratio of Li to Ti to Fe was 1.2:0.4:0.4; were mixed in pure water by stirring; and were then uniformly dispersed using a sand grinder mill (manufactured by Shinmaru Enterprises Corporation). The dispersion was dried, followed by calcination at 650° C. for five hours, whereby iron-containing lithium titanate was prepared. A lithium secondary battery was prepared using the iron-containing lithium titanate as a positive-electrode material. The iron-containing lithium titanate was used as a positive-electrode active material for a lithium secondary battery of Comparative Example 2 without performing any mechanochemical treatment with a carbonaceous material.

### Comparative Example 3

Titanyl sulfate (TiOSO₄, produced by TAYCA Corporation) and ferric sulfate (Fe₂(SO₄)₃) were weighed such that the Fe/Ti ratio was 1 and were dissolved in 60° C. water, whereby an iron-titanium mixture was prepared. Water was poured into another vessel, the iron-titanium mixture and a 28% aqueous solution of ammonia which was a neutralizer were added thereto at once under stirring, and iron and titanium were crystallized with the pH maintained at 8. A coprecipitate obtained by crystallization was filtered, was washed with water, was dried, and was crushed, whereby a Fe—Ti coprecipitate was obtained. Lithium hydroxide monohydrate (LiOH.H₂O) was added to the Fe—Ti coprecipitate and was mixed therewith in a planetary ball mill (manufactured by FRITSCH GmbH). The mixture was calcined at 500° C. for five hours in a nitrogen atmosphere, whereby iron-containing lithium titanate was obtained. To the obtained iron-containing lithium titanate, 5% by weight of Ketjenblack EC600JD (produced by Lion Corporation) serving as a carbonaceous material was added, followed by mixing at a rotation speed of 2,000 rpm for 30 minutes using Henschel Mixer® manufactured by Mitsui Mining Co., Ltd., whereby a positive-electrode active material for a lithium secondary battery of Comparative Example 3 was obtained.

Next, the prepared positive-electrode active materials for lithium secondary batteries of Examples 1 to 12 and Comparative Examples 1 to 3 were measured for Li content, Ti content, Fe content, moisture content, carbon content, powder conductivity, and green density. Results are shown in Table 1.

Furthermore, crystal structure analysis was performed using an X-ray diffraction analyzer (manufactured by PANalytical), so that indexing could be performed by a unit cell of LiTiO₂ or LiFeO₂ having a cubic rock-salt structure specified in known powder X-ray diffraction data.

The contents of Li, Ti, and Fe were analyzed by ICP emission spectrometry using an ICP-AES system (manufactured by SII NanoTechnology Kabushiki Kaisha). The content of carbon was measured using CN MACRO CORDER (manufactured by J-Science Lab.). The content of moisture was measured by the Karl Fischer method using a moisture analyzer (manufactured by Mitsubishi Materials Corporation). The powder conductivity was determined in such a manner that the resistance of powder pressurized with 20 kN was measured using a powder resistance measurement system MCP-PD51 (manufactured by Mitsubishi Chemical Analytech Co. Ltd.). The green density was determined in such a manner that a tablet was prepared by pressurizing with 10 kN using a tablet-molding machine (manufactured by Ichihashi Seiki Industry Co., Ltd.) and the weight and height of the tablet were measured.

TABLE 1

| | | | | | | Com- | | | | | | | |
|---|---|---|---|---|---|---|---|---|---|---|---|---|---|
| | | | | | | plexing | | | | | | | |
| | | | | | | step | | | | | | | |
| | | | | Calcination step | | Carbon | | | | Mois- | Carbon | | |
| | Raw materials | | | Calcination | | content | Element ratio | | | ture | content | Powder | Green |
| | | | Fe/Ti | temperature | Atmos- | (weight | Li | Fe | Ti | content | (weight | conductivity | density |
| | Fe source | Ti source | ratio | (° C.) | phere | percent) | (mol) | (mol) | (mol) | (ppm) | percent) | (S/cm) | (g/cc) |
| Example 1 | Ferric sulfate | Titanyl sulfate | 1.0 | 500 | Nitrogen | 5.0 | 1.20 | 0.40 | 0.40 | 1500 | 4.98 | 4.55 × 10⁻³ | 2.37 |
| Example 2 | Iron (III) | Titanyl sulfate | 1.0 | 500 | Nitrogen | 5.0 | 1.21 | 0.39 | 0.41 | 1520 | 5.01 | 4.13 × 10⁻³ | 2.39 |
| | chloride | | | | | | | | | | | | |
| Example 3 | Ferrous | Titanyl sulfate | 1.0 | 500 | Nitrogen | 5.0 | 1.20 | 0.40 | 0.40 | 1620 | 4.95 | 5.25 × 10⁻³ | 2.38 |
| | sulfate | | | | | | | | | | | | |
| Example 4 | Ferric sulfate | Titanium | 1.0 | 500 | Nitrogen | 5.0 | 1.20 | 0.40 | 0.39 | 1500 | 4.98 | 4.86 × 10⁻³ | 2.38 |
| | | sulfate | | | | | | | | | | | |
| Example 5 | Ferric sulfate | Titanium | 1.0 | 500 | Nitrogen | 5.0 | 1.20 | 0.40 | 0.40 | 1510 | 4.92 | 4.55 × 10⁻³ | 2.24 |
| | | tetrachloride | | | | | | | | | | | |
| Example 6 | Ferric sulfate | Titanyl sulfate | 1.0 | 500 | Nitrogen | 2.5 | 1.20 | 0.40 | 0.40 | 1300 | 2.53 | 4.55 × 10⁻³ | 2.39 |
| Example 7 | Ferric sulfate | Titanyl sulfate | 1.0 | 500 | Nitrogen | 10.0 | 1.20 | 0.40 | 0.40 | 8500 | 9.95 | 8.09 × 10⁻² | 2.16 |
| Example 8 | Ferric sulfate | Titanyl sulfate | 1.0 | 500 | Nitrogen | 0.5 | 1.20 | 0.40 | 0.40 | 1000 | 0.48 | 5.71 × 10⁻⁴ | 2.32 |
| Example 9 | Ferric sulfate | Titanyl sulfate | 2.3 | 500 | Nitrogen | 5.0 | 1.20 | 0.56 | 0.24 | 1520 | 4.97 | 4.20 × 10⁻³ | 2.38 |
| Example | Ferric sulfate | Titanyl sulfate | 0.4 | 500 | Nitrogen | 5.0 | 1.20 | 0.24 | 0.56 | 1511 | 4.93 | 4.55 × 10⁻³ | 2.33 |
| 10 | | | | | | | | | | | | | |
| Example | Ferric sulfate | Titanyl sulfate | 1.0 | 450 | Nitrogen | 5.0 | 1.20 | 0.39 | 0.39 | 3011 | 4.94 | 4.85 × 10⁻³ | 2.38 |
| 11 | | | | | | | | | | | | | |
| Example | Ferric sulfate | Titanyl sulfate | 1.0 | 650 | Nitrogen | 5.0 | 1.20 | 0.40 | 0.40 | 1200 | 4.98 | 4.15 × 10⁻³ | 2.39 |
| 12 | | | | | | | | | | | | | |
| Compar- | Iron (II) | Titanium (IV) | 1/3 | — | — | — | 1.20 | 0.40 | 0.40 | 7200 | N.D. | 7.75 × 10⁻⁷ | 1.70 |
| ative | sulfate | sulfate | | | | | | | | | | | |
| Example 1 | heptahydrate | | | | | | | | | | | | |
| Compar- | Iron (III) | Titanium oxide | 1.0 | 650 | Nitrogen | — | 1.20 | 0.40 | 0.40 | 500 | N.D. | 6.24 × 10⁻⁷ | 2.02 |
| ative | oxide | | | | | | | | | | | | |
| Example 2 | | | | | | | | | | | | | |
| Compar- | Ferric sulfate | Titanyl sulfate | 1.0 | 500 | Nitrogen | 5.0 | 1.20 | 0.40 | 0.40 | 1650 | 4.98 | 6.24 × 10⁻³ | 1.95 |
| ative | | | | | | | | | | | | | |
| Example 3 | | | | | | | | | | | | | |

As shown in Table 1, Examples 1 to 12 show higher green density as compared to Comparative Examples 1 to 3. In the case of simply mixing a carbonaceous material like Ketjenblack as described in Comparative Example 3, the conductivity more increased than iron-containing lithium titanate of other comparative examples and the green density did not increase. This shows that in Examples 1 to 12, the green density probably increased because carbon is physically strongly bonded to iron-containing lithium titanate by the mechanochemical treatment.

### Examples 13 to 24

Next, lithium secondary batteries of Examples 13 to 24 were prepared using the prepared positive-electrode active materials for lithium secondary batteries of Examples 1 to 12 as described below.

First, the positive-electrode active material for a lithium secondary battery of Example 1, acetylene black (produced by Denki Kagaku Kogyo Kabushiki Kaisha) which was a conductive agent, and polyvinylidene fluoride (produced by Kureha Corporation) which was a binder were weighed at a ratio of 8:1:1 and were added to an appropriate amount of N-methylpyrrolidone serving as a solvent, followed by kneading, whereby slurry was prepared. Next, the prepared slurry was applied to aluminum foil and was dried, whereby a plate was prepared. The plate was punched with a punching machine so as to have a circular shape.

Next, the punched plate was put in a case of a coin cell, LiPF₆ EC/DEC=1/2 vol % (produced by Kishida Chemical Co., Ltd.) serving as an electrolyte solution was added thereto, a polyolefin separator (produced by Asahi Kasei Corporation) was overlaid thereon, a metallic Li which was a counter electrode was put thereon, a lid was put thereon, and the lid was sealed with a swaging machine, whereby the lithium secondary battery of Example 13 was prepared. Incidentally, the lithium secondary battery was assembled in a glove box in an argon atmosphere.

Furthermore, the lithium secondary batteries of Examples 14 to 24 were prepared using the positive-electrode active materials for lithium secondary batteries of Examples 2 to 12 in substantially the same manner as that described in Example 13.

### Comparative Examples 4 to 6

Lithium secondary batteries of Comparative Examples 4 to 6 were prepared in substantially the same manner as that described in Example 13 except that the positive-electrode active materials for lithium secondary batteries of Comparative Examples 1 to 3 were used as a positive-electrode material.

Next, the lithium secondary batteries of Examples 13 to 24 and Comparative Examples 4 to 6 were evaluated for initial battery characteristics and storage characteristics. In particular, methods below were used.

(Evaluation of Initial Battery Characteristics)

Constant-current charge was performed up to 4.4 V at 0.1 mA/cm² using a charge/discharge system (manufactured by Hokuto Denko Corporation). After a pause for one hour, constant-current discharge was performed down to 1.0 V. In this operation, the charge capacity and the discharge capacity were measured. Incidentally, the fact that these values are large means that battery characteristics are good. Results are shown in Table 2.

(Evaluation of Storage Characteristics)

After constant-current charge was performed, the voltage just after charge was measured. Subsequently, it was stored for 30 days in a 60° C. thermostatic chamber and was then measured for voltage. The voltage drop rate during storage was calculated from the voltage just after charge and the voltage after storage for 30 days on the basis of an equation below, whereby storage characteristics were evaluated. Incidentally, the fact that the value of the voltage drop rate is small means that storage characteristics are good. Results are shown in Table 2.

(Voltage drop rate)=((voltage just after charge−voltage measured after storage for 30 days)/(voltage just after charge))×100(%)

TABLE 2

| | | | | | | Complexing | | | |
|---|---|---|---|---|---|---|---|---|---|
| | | | | | | step | Initial battery | | |
| | | | | Calcination step | | Carbon | characteristics | | Voltage drop |
| | Raw materials | | | Calcination | | content | Charge | Discharge | rate at 60° C. |
| | | | Fe/Ti | temperature | | (weight | capacity | capacity | storage |
| | Fe source | Ti source | ratio | (° C.) | Atmosphere | percent) | (mAh/g) | (mAh/g) | (%) |
| Example 13 | Ferric sulfate | Titanyl sulfate | 1.0 | 500 | Nitrogen | 5.0 | 283 | 273 | 12.1 |
| Example 14 | Iron (III) chloride | Titanyl sulfate | 1.0 | 500 | Nitrogen | 5.0 | 279 | 268 | 12.5 |
| Example 15 | Ferrous sulfate | Titanyl sulfate | 1.0 | 500 | Nitrogen | 5.0 | 266 | 251 | 12.3 |
| Example 16 | Ferric sulfate | Titanium sulfate | 1.0 | 500 | Nitrogen | 5.0 | 278 | 266 | 12.0 |
| Example 17 | Ferric sulfate | Titanium | 1.0 | 500 | Nitrogen | 5.0 | 276 | 263 | 12.6 |
| | | tetrachloride | | | | | | | |
| Example 18 | Ferric sulfate | Titanyl sulfate | 1.0 | 500 | Nitrogen | 2.5 | 276 | 264 | 13.2 |
| Example 19 | Ferric sulfate | Titanyl sulfate | 1.0 | 500 | Nitrogen | 10.0 | 282 | 270 | 18.0 |
| Example 20 | Ferric sulfate | Titanyl sulfate | 1.0 | 500 | Nitrogen | 0.5 | 268 | 253 | 13.1 |
| Example 21 | Ferric sulfate | Titanyl sulfate | 2.3 | 500 | Nitrogen | 5.0 | 275 | 264 | 13.2 |
| Example 22 | Ferric sulfate | Titanyl sulfate | 0.4 | 500 | Nitrogen | 5.0 | 274 | 263 | 12.4 |
| Example 23 | Ferric sulfate | Titanyl sulfate | 1.0 | 450 | Nitrogen | 5.0 | 268 | 251 | 14.2 |
| Example 24 | Ferric sulfate | Titanyl sulfate | 1.0 | 650 | Nitrogen | 5.0 | 264 | 253 | 11.0 |
| Comparative | Iron (II) sulfate | Titanium (IV) | 1/3 | — | — | — | 264 | 252 | 20.1 |
| Example 4 | heptahydrate | sulfate | | | | | | | |
| Comparative | Iron (III) oxide | Titanium oxide | 1.0 | 650 | Nitrogen | — | 210 | 201 | 32.0 |
| Example 5 | | | | | | | | | |
| Comparative | Ferric sulfate | Titanyl sulfate | 1.0 | 500 | Nitrogen | 5.0 | 262 | 258 | 23.2 |
| Example 6 | | | | | | | | | |

As shown in Table 2, for initial battery characteristics, all the lithium secondary batteries of Examples 13 to 24 have a charge-discharge capacity equal to or more than that of the lithium secondary batteries of Comparative Examples 4 to 6. Incidentally, Comparative Example 5 shows significantly inferior characteristics as compared to the other examples. This is probably due to the influences of the mixing state of Ti and Fe and the growth of particles by high-temperature calcination.

For storage characteristics, all the lithium secondary batteries of Examples 13 to 24 have a reduced voltage drop as compared to the lithium secondary batteries of Comparative Examples 4 to 6 and are good. This is probably because the moisture content of the lithium secondary batteries of Comparative Examples 4 to 6 is high and therefore HF is produced by the reaction of moisture with the electrolyte solution to dissolve Fe and Ti on the surface of iron-containing lithium titanate, which causes a voltage drop.

### Examples 25 to 36

Next, positive-electrode active materials for lithium secondary batteries were prepared by a manufacturing method including a synthesis step in which iron-containing lithium titanate is synthesized by applying a microwave and lithium secondary batteries were prepared using the positive-electrode active materials for lithium secondary batteries.

### Example 25

First, titanyl sulfate (TiOSO₄, produced by TAYCA Corporation) and ferric sulfate (Fe₂(SO₄)₃) were weighed such that the molar ratio of Fe to Ti was 1 and were dissolved in 60° C. water, whereby a Fe—Ti mixture solution was prepared.

Next, the Fe—Ti mixture solution and a 28% aqueous solution of ammonia which was a neutralizer were added to a vessel containing water at once under stirring and crystallization was carried out with the pH maintained at about 8.

Next, a crystallized coprecipitate was washed with water, was dried, and was crushed, whereby a Fe—Ti coprecipitate was obtained.

Next, to 5.2 g of the Fe—Ti coprecipitate, 40 g of a 3.8 M aqueous solution of lithium hydroxide was added, followed by stirring for ten minutes, whereby slurry was prepared. Thereafter, the slurry was poured into a Teflon® vessel, was covered with a lid, and was then heated using a microwave synthesis system (Milestone General K.K.) under conditions including a power of 500 W, a temperature of 200° C., a heating-up time of 20 minutes, and a holding time of 30 minutes, whereby iron-containing lithium titanate was synthesized.

Finally, to the iron-containing lithium titanate, 2% by weight of Ketjenblack (EC600JD, produced by Lion Corporation) serving as a carbonaceous material was added, followed by a mechanochemical treatment using a planetary ball mill under conditions including a rotation speed of 300 rpm and a treatment time of 30 minutes, whereby a positive-electrode active material for a lithium secondary battery of Example 25 was prepared.

### Example 26

A positive-electrode active material for a lithium secondary battery of Example 26 was prepared in substantially the same manner as that described in Example 25 except that an iron source was changed to iron (III) chloride (FeCl₃).

### Example 27

A positive-electrode active material for a lithium secondary battery of Example 27 was prepared in substantially the same manner as that described in Example 25 except that an iron source was changed to ferrous sulfate (FeSO₄).

### Example 28

A positive-electrode active material for a lithium secondary battery of Example 28 was prepared in substantially the same manner as that described in Example 25 except that a titanium source was changed to titanium sulfate (Ti(SO₄)₂).

### Example 29

A positive-electrode active material for a lithium secondary battery of Example 29 was prepared in substantially the same manner as that described in Example 25 except that a titanium source was changed to titanium tetrachloride (TiCl₄).

### Example 30

A positive-electrode active material for a lithium secondary battery of Example 30 was prepared in substantially the same manner as that described in Example 25 except that the holding time during the application of a microwave was changed to ten minutes.

### Example 31

A positive-electrode active material for a lithium secondary battery of Example 31 was prepared in substantially the same manner as that described in Example 25 except that the holding time during the application of a microwave was changed to 40 minutes.

### Example 32

A positive-electrode active material for a lithium secondary battery of Example 32 was prepared in substantially the same manner as that described in Example 25 except that the holding time during the application of a microwave was changed to 60 minutes.

### Example 33

A positive-electrode active material for a lithium secondary battery of Example 33 was prepared in substantially the same manner as that described in Example 25 except that the molar ratio (Fe/Ti ratio) of iron to titanium was changed to 2.3 in a coprecipitation step.

### Example 34

A positive-electrode active material for a lithium secondary battery of Example 34 was prepared in substantially the same manner as that described in Example 25 except that the molar ratio (Fe/Ti ratio) of iron to titanium was changed to 0.4 in a coprecipitation step.

### Example 35

A positive-electrode active material for a lithium secondary battery of Example 35 was prepared in substantially the same manner as that described in Example 25 except that the synthesis temperature during the application of a microwave was changed to 150° C.

### Example 36

A positive-electrode active material for a lithium secondary battery of Example 36 was prepared in substantially the same manner as that described in Example 25 except that the synthesis temperature during the application of a microwave was changed to 240° C.

Next, the prepared positive-electrode active materials for lithium secondary batteries of Examples 25 to 36 and the above positive-electrode active materials for lithium secondary batteries of Comparative Examples 1 and 2 were measured for crystallite diameter, Li content, Ti content, Fe content, moisture content, and carbon content and were subjected to crystal structure analysis.

In particular, the crystallite diameter was measured using an X-ray diffraction analyzer (manufactured by PANalytical). The contents of Li, Ti, and Fe were measured by ICP emission spectrometry using an ICP-AES system (manufactured by SII NanoTechnology Kabushiki Kaisha). The content of moisture was measured by the Karl Fischer method using a moisture analyzer (manufactured by Mitsubishi Materials Corporation). The specific surface area was measured by the BET method. The content of carbon was measured using CN MACRO CORDER (manufactured by J-Science Lab.). Results are shown in Table 3.

TABLE 3

| | | | | | | Com- | | | | | | | |
|---|---|---|---|---|---|---|---|---|---|---|---|---|---|
| | | | | | | plexing | | | | | | | |
| | | | | | | step | | | | | | | |
| | | | | Microwave synthesis | | Carbon | | | | | Specific | Mois- | Carbon |
| | Raw materials | | | | Holding | content | Element ratio | | | Crystallite | surface | ture | content |
| | | | Fe/Ti | Temperature | time | (weight | Li | Fe | Ti | diameter | area | content | (weight |
| | Fe source | Ti source | ratio | (° C.) | (minutes) | percent) | (mol) | (mol) | (mol) | (nm) | (m²/g) | (ppm) | percent) |
| Example | Ferric sulfate | Titanyl sulfate | 1.0 | 200 | 30 | 2.0 | 1.20 | 0.40 | 0.40 | 25 | 98 | 980 | 2.05 |
| 25 | | | | | | | | | | | | | |
| Example | Iron (III) | Titanyl sulfate | 1.0 | 200 | 30 | 2.0 | 1.21 | 0.39 | 0.41 | 24 | 95 | 992 | 2.06 |
| 26 | chloride | | | | | | | | | | | | |
| Example | Ferrous | Titanyl sulfate | 1.0 | 200 | 30 | 2.0 | 1.20 | 0.40 | 0.40 | 28 | 93 | 1001 | 2.05 |
| 27 | sulfate | | | | | | | | | | | | |
| Example | Ferric sulfate | Titanium sulfate | 1.0 | 200 | 30 | 2.0 | 1.20 | 0.40 | 0.39 | 24 | 95 | 1005 | 2.01 |
| 28 | | | | | | | | | | | | | |
| Example | Ferric sulfate | Titanium | 1.0 | 200 | 30 | 2.0 | 1.20 | 0.40 | 0.40 | 25 | 92 | 981 | 2.03 |
| 29 | | tetrachloride | | | | | | | | | | | |
| Example | Ferric sulfate | Titanyl sulfate | 1.0 | 200 | 10 | 2.0 | 1.20 | 0.40 | 0.40 | 18 | 110 | 1200 | 2.04 |
| 30 | | | | | | | | | | | | | |
| Example | Ferric sulfate | Titanyl sulfate | 1.0 | 200 | 40 | 2.0 | 1.20 | 0.40 | 0.40 | 26 | 97 | 980 | 2.07 |
| 31 | | | | | | | | | | | | | |
| Example | Ferric sulfate | Titanyl sulfate | 1.0 | 200 | 60 | 2.0 | 1.20 | 0.40 | 0.40 | 28 | 70 | 1010 | 2.06 |
| 32 | | | | | | | | | | | | | |
| Example | Ferric sulfate | Titanyl sulfate | 2.3 | 200 | 30 | 2.0 | 1.20 | 0.56 | 0.24 | 24 | 95 | 995 | 2.04 |
| 33 | | | | | | | | | | | | | |
| Example | Ferric sulfate | Titanyl sulfate | 0.4 | 200 | 30 | 2.0 | 1.20 | 0.24 | 0.56 | 32 | 89 | 980 | 2.04 |
| 34 | | | | | | | | | | | | | |
| Example | Ferric sulfate | Titanyl sulfate | 1.0 | 150 | 30 | 2.0 | 1.20 | 0.39 | 0.39 | 10 | 120 | 1200 | 2.03 |
| 35 | | | | | | | | | | | | | |
| Example | Ferric sulfate | Titanyl sulfate | 1.0 | 240 | 30 | 2.0 | 1.20 | 0.40 | 0.40 | 40 | 80 | 950 | 2.05 |
| 36 | | | | | | | | | | | | | |
| Compar- | Iron (II) | Titanium (IV) | 1/3 | — | — | — | 1.20 | 0.40 | 0.40 | 210 | 18 | 7200 | N.D |
| ative | sulfate | sulfate | | | | | | | | | | | |
| Example 1 | heptahydrate | | | | | | | | | | | | |
| Compar- | Iron (III) | Titanium oxide | 1.0 | — | — | — | 1.20 | 0.40 | 0.40 | 300 | 5 | 500 | N.D |
| ative | oxide | | | | | | | | | | | | |
| Example 2 | | | | | | | | | | | | | |

As is clear from the results shown in Table 3, all the positive-electrode active materials for lithium secondary batteries of Examples 25 to 36 had a crystallite diameter of 5 nm to 100 nm and the contents of Li, Ti, and Fe were a composition formula represented by Li₁₋ₓ(Ti_{1-y}Fe_{y})₁₋ₓO₂ (0<x≦0.3 and 0<y≦0.8).

Furthermore, all the positive-electrode active materials for lithium secondary batteries of Examples 25 to 36 had a moisture content of 2,000 ppm or less.

Furthermore, all the positive-electrode active materials for lithium secondary batteries of Examples 25 to 36 had a specific surface area of 20 m²/g to 150 m²/g.

Incidentally, as a result of crystal structure analysis, all the positive-electrode active materials for lithium secondary batteries of Examples 25 to 36 could be indexed by a unit cell of LiTiO₂ or LiFeO₂ having a cubic rock-salt structure specified in known powder X-ray diffraction data.

In contrast, the positive-electrode active materials for lithium secondary batteries of Comparative Examples 1 and 2 had a crystallite diameter of more than 100 nm and a specific surface area of less than 20 m²/g. In particular, the moisture content of the positive-electrode active material for a lithium secondary battery of Comparative Example 1 was very high, 7,200 ppm.

Next, lithium secondary batteries of Examples 37 to 48 were prepared by the preparation method described in paragraph [0077] using the prepared positive-electrode active materials for lithium secondary batteries of Examples 25 to 36 and were evaluated for storage characteristics together with lithium secondary batteries of Comparative Examples 4 and 5. Results are shown in Table 4.

TABLE 4

| | | | | Microwave synthesis | | Complexing step | Voltage drop rate |
|---|---|---|---|---|---|---|---|
| | Raw materials | | | Temperature | Holding time | Carbon content | at 60° C. storage |
| | Fe source | Ti source | Fe/Ti ratio | (° C.) | (minutes) | (weight percent) | (%) |
| Example 37 | Ferric sulfate | Titanyl sulfate | 1.0 | 200 | 30 | 2.0 | 3.7 |
| Example 38 | Iron (III) chloride | Titanyl sulfate | 1.0 | 200 | 30 | 2.0 | 3.5 |
| Example 39 | Ferrous sulfate | Titanyl sulfate | 1.0 | 200 | 30 | 2.0 | 3.4 |
| Example 40 | Ferric sulfate | Titanium sulfate | 1.0 | 200 | 30 | 2.0 | 3.7 |
| Example 41 | Ferric sulfate | Titanium tetrachloride | 1.0 | 200 | 30 | 2.0 | 3.8 |
| Example 42 | Ferric sulfate | Titanyl sulfate | 1.0 | 200 | 10 | 2.0 | 3.9 |
| Example 43 | Ferric sulfate | Titanyl sulfate | 1.0 | 200 | 40 | 2.0 | 3.4 |
| Example 44 | Ferric sulfate | Titanyl sulfate | 1.0 | 200 | 60 | 2.0 | 3.7 |
| Example 45 | Ferric sulfate | Titanyl sulfate | 2.3 | 200 | 30 | 2.0 | 4.1 |
| Example 46 | Ferric sulfate | Titanyl sulfate | 0.4 | 200 | 30 | 2.0 | 3.1 |
| Example 47 | Ferric sulfate | Titanyl sulfate | 1.0 | 150 | 30 | 2.0 | 4.2 |
| Example 48 | Ferric sulfate | Titanyl sulfate | 1.0 | 240 | 30 | 2.0 | 3.8 |
| Comparative | Iron (II) sulfate | Titanium (IV) sulfate | 1/3 | — | — | — | 20.1 |
| Example 4 | heptahydrate | | | | | | |
| Comparative | Iron (III) oxide | Titanium oxide | 1.0 | — | — | — | 32.0 |
| Example 5 | | | | | | | |

As is clear from Table 4, all the lithium secondary batteries of Examples 37 to 48 had a voltage drop rate of 5% or less. In contrast, the lithium secondary batteries of Comparative Examples 4 and 5 had a voltage drop rate of more than 5% and were batteries with poor storage characteristics.

From the above results, in accordance with a positive-electrode active material for a lithium secondary battery according to the present invention, it has become clear that in the case of using the positive-electrode active material as a positive-electrode material for a lithium secondary battery, a lithium secondary battery with more excellent storage characteristics than ever can be obtained.

Furthermore, in accordance with a method for manufacturing a positive-electrode active material according to the present invention, it has become clear that an unreacted lithium source remaining on the surface of iron-containing lithium titanate after synthesis can be reduced and a lithium secondary battery with excellent storage characteristics can be obtained in the case of using iron-containing lithium titanate for a positive-electrode active material for a lithium secondary battery. Furthermore, it has become clear that the positive-electrode active material can be obtained in an extremely short time at low cost.

### INDUSTRIAL APPLICABILITY

The present invention can be applied to a positive-electrode active material for a lithium secondary battery.

1-15. (canceled)

16. A positive-electrode active material for a lithium secondary battery, containing:
iron-containing lithium titanate that has a cubic rock-salt structure and that can be represented by the composition formula Li₁₊ₓ(Ti_{1-y}Fe_{y})₁₋ₓO₂ (with 0<x≦0.3 and 0<y≦0.8); and
a carbonaceous material,
wherein the iron-containing lithium titanate and the carbonaceous material are complexed together via a mechanochemical treatment and the crystallite diameter is 10 nm to 40 nm.

17. The positive-electrode active material for a lithium secondary battery according to claim 16, containing 0.5% to 10% by weight of the carbonaceous material.

18. The positive-electrode active material for a lithium secondary battery according to claim 16, having a moisture content of 2,000 ppm or less.

19. The positive-electrode active material for a lithium secondary battery according to claim 16, having a specific surface area of 20 m²/g to 150 m²/g as determined by the BET method.

20. The positive-electrode active material for a lithium secondary battery according to claim 16, having a voltage drop rate of 5% or less as calculated from the following equation:
(voltage drop rate)=((voltage just after charge−voltage measured after storage for 30 days)/(voltage just after charge))×100(%).

21. A method for manufacturing the positive-electrode active material for a lithium secondary battery according to claim 16, the method comprising:
a coprecipitation step in which a solution containing an iron source and a titanium source is neutralized by an alkaline solution, washed with water, and dried to produce a Fe—Ti coprecipitate;
a mixing step in which the coprecipitate is mixed with a lithium source to produce a mixture;
a calcination step in which the mixture is calcined to produce a calcination product; and
a complexing step in which the calcination product is complexed with a carbonaceous material via a mechanochemical treatment.

22. The method for manufacturing the positive-electrode active material for a lithium secondary battery according to claim 21, wherein the calcination step is performed in an inert gas atmosphere.

23. The method for manufacturing the positive-electrode active material for a lithium secondary battery according to claim 21, wherein the calcination step is performed at a temperature of 400° C. to 700° C.

24. A method for manufacturing the positive-electrode active material for a lithium secondary battery according to claim 16, the method comprising:
a coprecipitation step in which a solution containing an iron source and a titanium source is neutralized by an alkaline solution, washed with water, and dried to produce a Fe—Ti coprecipitate;
a mixing step in which the coprecipitate is mixed with a lithium source to produce a mixture;
a synthesis step in which the mixture is irradiated with a microwave to produce iron-containing lithium titanate; and
a complexing step in which the iron-containing lithium titanate is complexed with a carbonaceous material via a mechanochemical treatment.

25. The method for manufacturing the positive-electrode active material for a lithium secondary battery according to claim 24, wherein the synthesis step is performed at a temperature of 100° C. to 250° C.

26. The method for manufacturing the positive-electrode active material for a lithium secondary battery according to claim 21, wherein the iron source is one or more of Fe₂(SO₄)₃, FeSO₄, FeCl₃, and Fe(NO₃)₃.

27. The method for manufacturing the positive-electrode active material for a lithium secondary battery according to claim 21, wherein the titanium source is one or more of Ti(SO₄)₂, TiOSO₄, and TiCl₄.

28. The method for manufacturing the positive-electrode active material for a lithium secondary battery according to claim 24, wherein the iron source is one or more of Fe₂(SO₄)₃, FeSO₄, FeCl₃, and Fe(NO₃)₃.

29. The method for manufacturing the positive-electrode active material for a lithium secondary battery according to claim 24, wherein the titanium source is one or more of Ti(SO₄)₂, TiOSO₄, and TiCl₄.

30. A positive electrode for a lithium secondary battery comprising a layer which is placed on a surface of a current collector and which is made of the positive-electrode active material for a lithium secondary battery according to claim 16.

31. A lithium secondary battery comprising the positive electrode for a lithium secondary battery according to claim 30.
